(19) United States
(12) Patent Application Publication
(10) Pub. No.: US 2004/0094295 A1
(43) Pub. Date: May 20, 2004

(54) Evaporative heat exchanger of streamline cross section tube coil with less even without cooling fins

(75) Inventors: Ho Hsin Wu, I-Lan (TW); Charles Y. Dean, Taipei (TW)

Correspondence Address: TROXELL LAW OFFICE PLLC, SUITE 1404, 5205 LEESBURG PIKE, FALLS CHURCH, VA, 22041, US

(73) Assignee: Air Tech. Co., Ltd.

(21) Appl. No.: 10/349,213

(22) Filed: Jan. 23, 2003

(30) Foreign Application Priority Data
Nov. 18, 2002 (TW) 091218514

(51) Int. Cl. F28D 1/00; A23C 3/04; F28D 3/02; G05D 9/00; F28F 27/00

(52) U.S. Cl. 165/302; 165/115; 165/117

(57) ABSTRACT

An evaporative heat exchanger of a medium condenser of a air condition system with less cooling fins even without cooling fins which a novel coil assembly composed of a plurality of streamline cross sectional tubes is used to instead of conventional round tubes for providing an ultra high evaporative efficiency therefore, and having the further improvement of easy to clean and convenient for maintenance.

### BACKGROUND OF THE INVENTION

The heat exchangers of cooling medium condensing apparatuses conventionally include three types, namely, the air cooling type, the water cooling type and the evaporative type. It is known that the heat dissipation efficiency of a water cooling type heat exchanger is slightly better than air cooling type ones, but the heat dissipation efficiency of an evaporative cooling type heat exchanger is much better than a water cooling type ones because that one liter of water absorbs 1 Kcal of heat when raising 1° C., but absorbs 539 Kcal when evaporated.

In addition the cooling efficiency by directly dissipating heat from coil tubes should be better than by indirectly dissipated from cooling fins which the heat have to be transferred to cooling fins from coil tubes first.

Therefor, how to insure a high evaporation efficiency for evaporating the water directly on the surface of tubes of the medium coil will be a most important problem has to be solved.

Further more, a conventional heat exchanger composed of a plurality of cooling fins with high density of 13 pieces per inch up to 17 pieces per inch, there will be easy to deposit dirt and sediment to corrupt the cooling fins, and having no enough spacing for cleaning and inconvenient for maintenance.

The present invention have been solved the problem by utilizing streamline cross sectional tube to instead of conventional round tube used for medium coil with less even without cooling fins.

FIG. 1A showing a wind flow “w” blows passing through a conventional round tube R having a water film thereon, which the wind “w” divided into two flows around the surface of both side of the round tube respectively to a point F and F′at the rear portion after passed over the diameter DD′ thereof, then the wind flows leave the tube surface and going directly to the back side, therefor the wind flow “w” dose not blow over the surface of the arc FF′ to produce evaporating effects, it is a great loss of evaporative efficiency therefore, because the surface around the arc FF′ is almost larger than ⅓ of the surface of a whole tube, further more there will a turbulence of eddy current “C” and a windless zone “T” be occurred at a rear space behind the tube to effect a poor cooling efficiency of the next row tubes of the coil.

FIG. 1B showing a wind flow “w” blows passing through a streamline tube S according to the present invention which a wind flow blows target to a larger head portion of a streamline tube the wind flow “w” divided into two opposite path around the streamline surface of the tube to a gradually reduced rear portion the wind flow will blows still around the streamline surface after passed over the diameter DD′ to an end edge “E”, and there will be no eddy current and no windless zone occurred, further more according to the theory of aerodynamics that the wind speed will increases while the wind blows over the rear portion surface of the streamline tube from point D(&D′) to the end edge point E and a negative pressure “P” will be provide thereat so as to increase a large amount of evaporative efficiency while a water film is held instantly on the surface of the tubes.

A Taiwanese utility model application of S/N 73202991 have simply mentioned that a streamline tube can be used for a heat exchanger. However the document did not have further description to define what type of heat exchanger been utilized and even have no further description for a practical technology to teach how to use it.

Meanwhile the present invention is quit different having defined a practical technology of heat exchanger with less even without cooling fins by using streamline tubes for medium coils.

Therefore, essentially a coordinate non-pressure water feeding system is employed in the present invention to supply evaporative water for providing a water film held on the surface of the tubes for an instance to give enough time for fully evaporated therefrom.

Further more, in case of the evaporative efficiency is fully developed directly by the coil of streamline tubes itself, the numbers of indirect heat dissipation cooling fins can be greatly reduced to a minimum even can be fully omitted, therefore it will be easy to clean and convenient for maintenance to provide a long life time for using.

Therefore a major object of the present invention is to provide an evaporative heat exchanger of a condenser of an air conditioning system which the medium coil is composed of a plurality of streamline cross sectional tubes to instead conventional round tubes so as to highly increase the evaporative cooling efficiency therefore.

Another major object of the present invention is to provide an evaporative heat exchanger which the numbers of conventional cooling fins can be greatly reduced to a minimum even to avoid the using of cooling fins so as to save a large amount of manufacturing cost.

Still another main object is to provide an evaporative heat exchanger with less even without cooling fins which will be easy to clean and convenient for maintenance.

### SUMMARY OF THE INVENTION

The present invention relates to a coil assembly for use in a water evaporative type heat exchanger of a cooling medium condensing apparatus especially relates to a coil assembly which a plurality of streamline cross sectional tubes are used to instead of the conventional round cross sectional tubes for highly improving the evaporating efficiency to maintain a high E.E.R. thereof, in which the number of cooling fins can be greatly reduced to a minimum even be completely omitted to a bare coil for providing the improvement of easy to clean and convenient for maintenance therefore.

### BRIEF INTRODUCTION OF THE DRAWINGS

FIG. 1A shows a wind flow blows over a conventional round cross sectional tube.

FIG. 1B shows a wind flow blows over a streamline cross sectional tube according the present invention.

FIG. 2 is a side view of a preferable embodiment according the present invention to show a plurality of streamline tubes arranged for coils in a tilted angle.

FIG. 3 is a perspective view of an embodiment of a complete condenser apparatus according the present invention.

FIG. 3A is a perspective view of a detailed construction of a recycling water tank.

FIGS. 4 and 4A showing a water recycling cooling coil and a water distributor of a foaming material pad feeding evaporative water to the medium coil tubes.

FIGS. 5, 5A and 5B shows multiple rows of needles pierced through the foaming material pad to provide water drops by a needle tip effect.

FIG. 6 is a perspective view of another preferable embodiment avoiding to use cooling fins.

FIG. 7 is a cross sectional view of a tadpole shaped streamline tube having a tail fin extended from a tail edge thereof.

FIG. 8 is a side view of a heat exchanger with tadpole shaped coil tube without cooling fins.

FIG. 9A to FIG. 9F shows other preferable embodiment of different arrangement of the coil and the water feeding system.

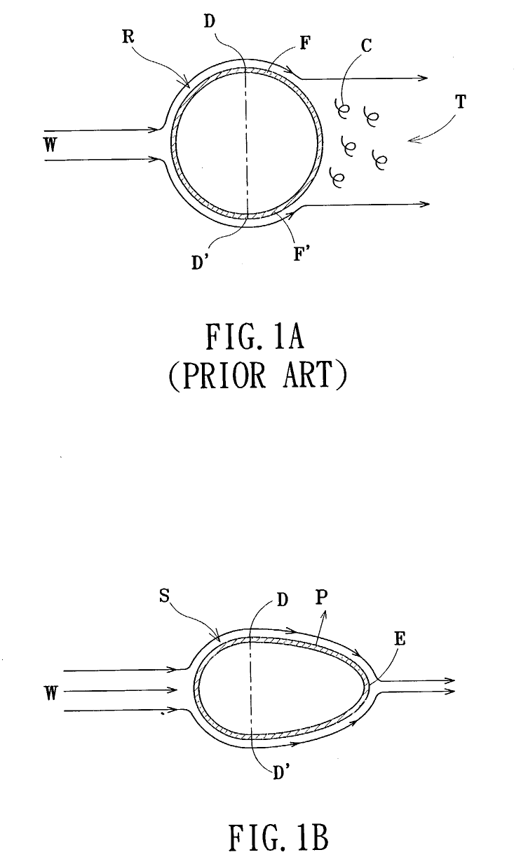

### DETAIL DESCRIPTION OF THE PRESENT INVENTION

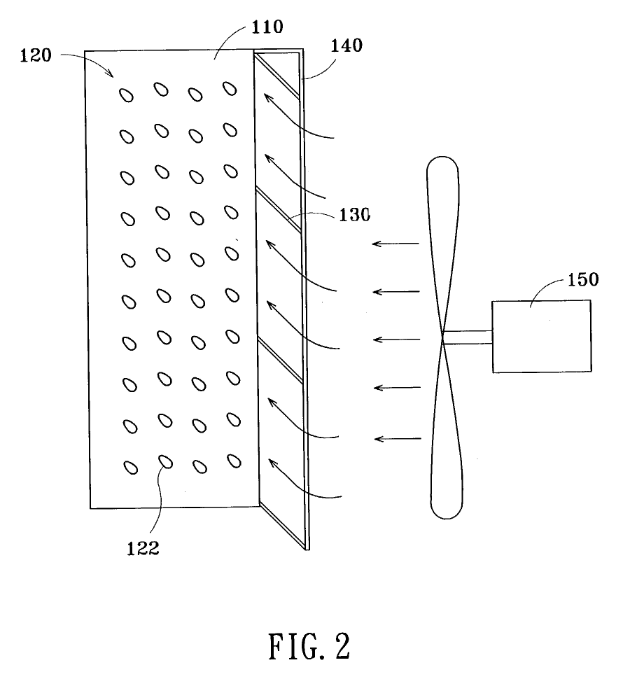

Referring to FIG. 2, a heat exchanger 110 is composed of a plurality of streamline cross section tubes 122 paralleled with a tilted slop formed of at least one set of coil 120 therefore, a plurality of wind guiding plate 130 disposed on a supporting frame 140 to guide the wind from a fan system 150 to a direction in parallel with the slop of the streamline tubes to insure that the wind flow will be passing through the surface of the streamline tubes smoothly to provide a maximum evaporative cooling efficiency while a water film is covered thereon.

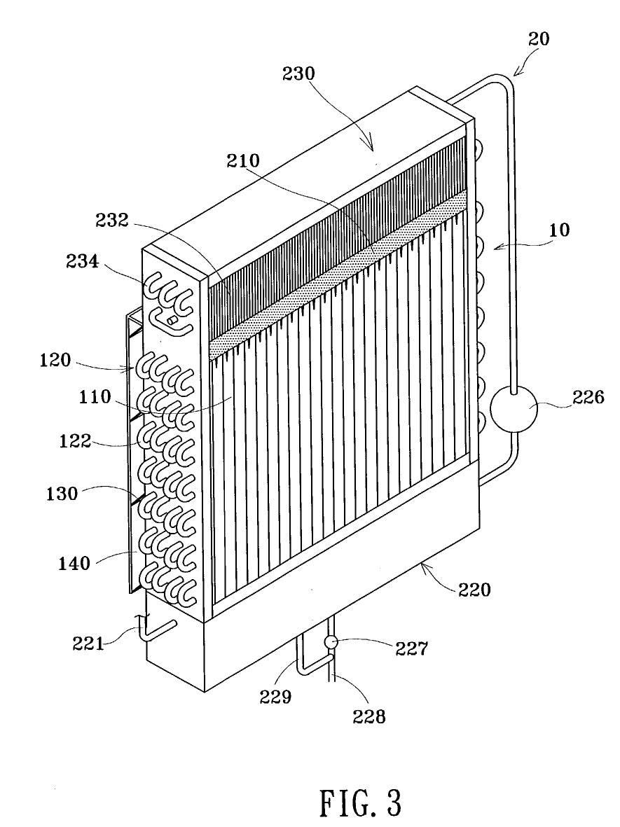

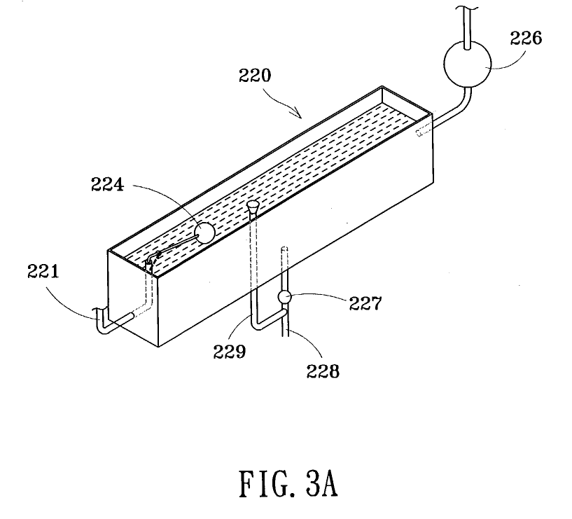

Referring to FIG. 3, it shows an embodiment of a complete condenser apparatus 10 according to the present invention, which the numbers of vertical fins 110 has been reduced to provide a wide interval between adjacent fins, the medium coil 120 is composed of a plurality of streamline tubes 122, a plurality of wind guiding plate 130 disposed on a supporting frame 140 at one side (back side as shown), a fan system 150 (not shown, please referring to FIG. 2) delivering a wind flow to blow over the surface of the streamline tubes; a evaporative water recycling feeding system 20 compressing a water distributor 210 of water absorptive foaming material disposed over a top of the cooling fins 110 for seeping non-pressure water drops to distribute water gently and evenly so as to maintain a water film to be held on the surface of tube 122 having enough time to fully evaporated therefrom, a water tank 220 disposed under the cooling fins 110 to supply evaporative water and collecting the residual water from the cooling fins 110 then ready for recycling by a pump 260, a recycling water pre-cooling heat exchanger 230 disposed at a top over the water distributor pad 210 comprising a plurality of vertical cooling fins 232 and a water coil 234 laterally pierced the fins 232 for pre-cooling the recycling water to avoid an over heat due to an accumulating effect of temperature raising in a long time running therefore.

Refer to FIG. 3A, it shows a detailed construction of a recycling water tank 220 having a fresh water supply inlet pipe 221 connected to a water source, a floating valve 224 to control the water keeping in a constant level, an automatic blow down valve 237 disposed on to a blow down pipe 228 under the tank 220 automatically operated periodically once daily or by-daily to change the recycled water into fresh water therefore, an over flow exhaust pipe 229 extended out from a bottom of the tank 220 and connected to the blow down pipe 228 by passed the blow down valve 227, having a horn type opening head inside the tank 220 with a height just flat to the constant water level used to exhaust the over flow water which a great amount of residual water falls down to the tank 220 in an instance while to cut off the apparatus.

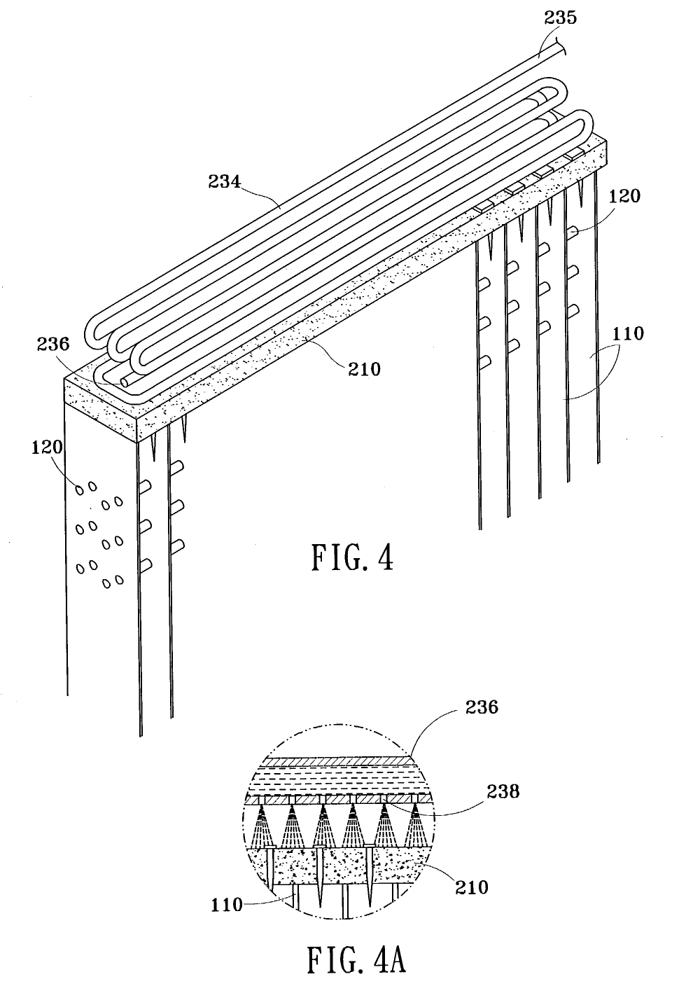

Please referring to FIG. 4 and FIG. 4A, which FIG. 4 shows a water coil 234 of a recycling water pre-cooling heat exchanger 20 having a recycling water inlet 235 connected from the pump 260 (see FIG. 3) and a tail tube 236 to spray water on to the water distributor 210, while FIG. 4A is a partial sectional view to show the tail tube 236 spraying water onto the water distributor 210 from a plurality of spray holes 238 thereof.

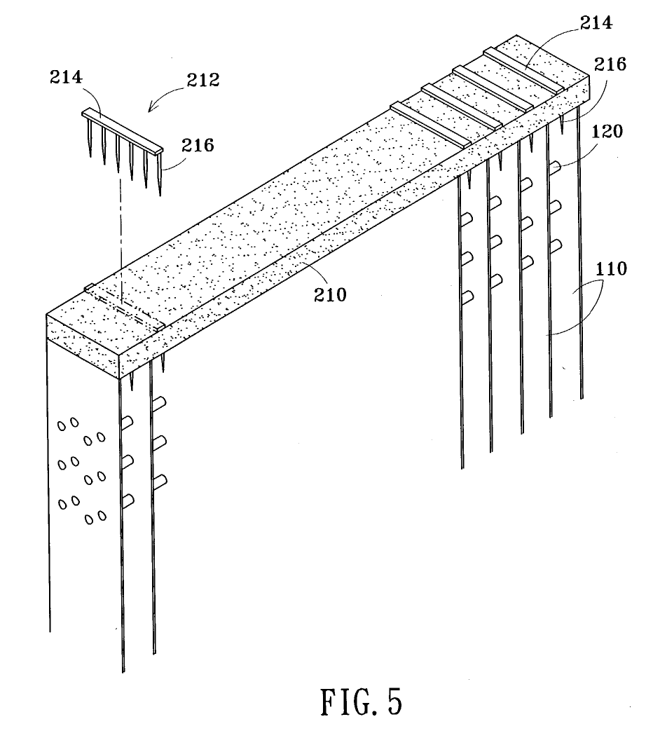

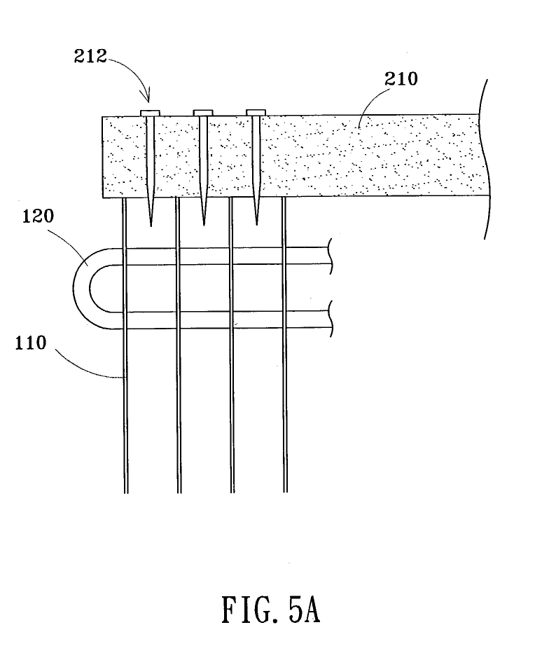

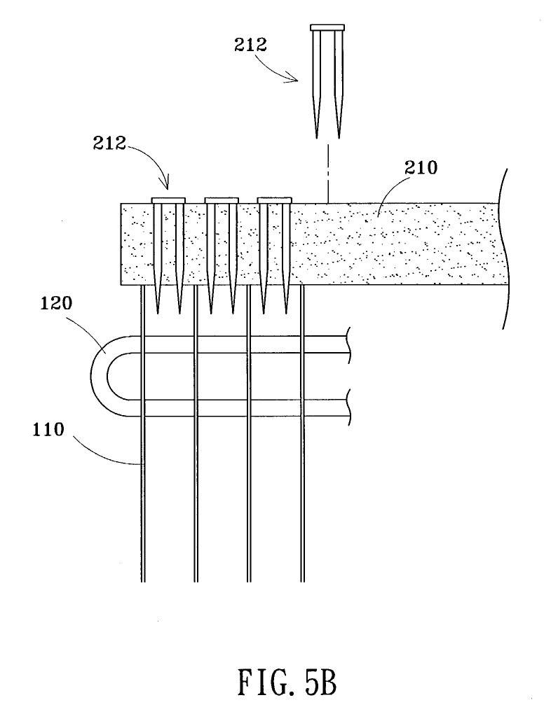

Refer to FIGS. 5, 5A and 5B, which a plurality of rows of needle set 212 with the needle tips 216 pierced out the bottom of the water distributor 210 at the intervals between adjacent cooling fins 110 to guiding the seeping water falling down to the streamline tubes drop by drop in a non-pressure manner so as to provide a water film held on the surface of the streamline tube for an instance to have enough time for fully evaporated while the wind flow blows therefor.

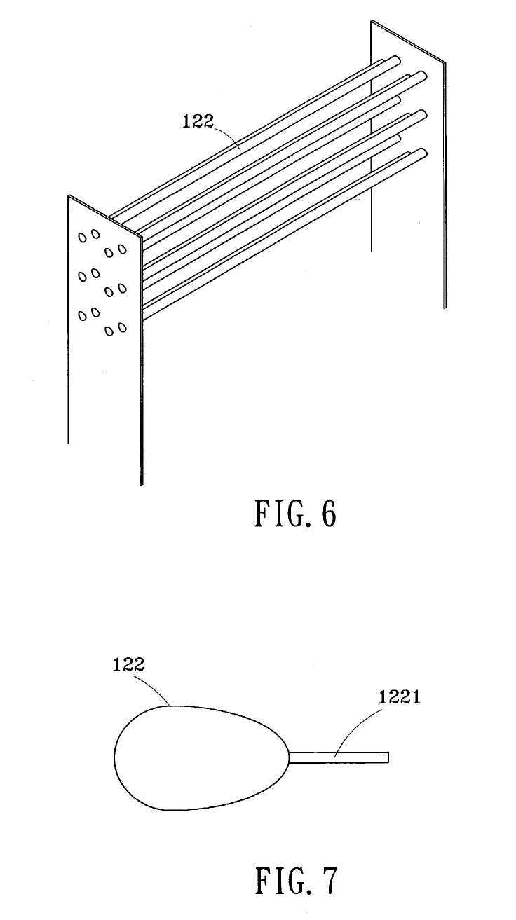

Refer to FIG. 6, a bare coil of streamline tubes 122 is composed to avoid the using of cooling fins, which has the improvement of easy to clean and convenient for maintenance therefore.

Now please refer to FIG. 7, a tadpole shaped cross sectional tube has a streamline tube 122 with a tail fin 1221 extended from a tail edge thereof, which is used for a bare coil to increase the cooling area of water evaporating.

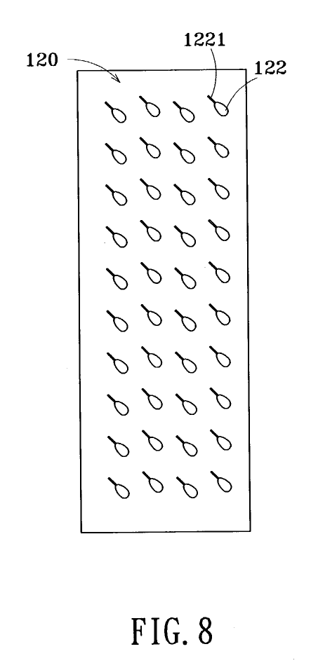

Refer to FIG. 8, it is a side view of an embodiment of a bare coil composed of a tadpole shaped streamline tube with a tilt angle thereat.

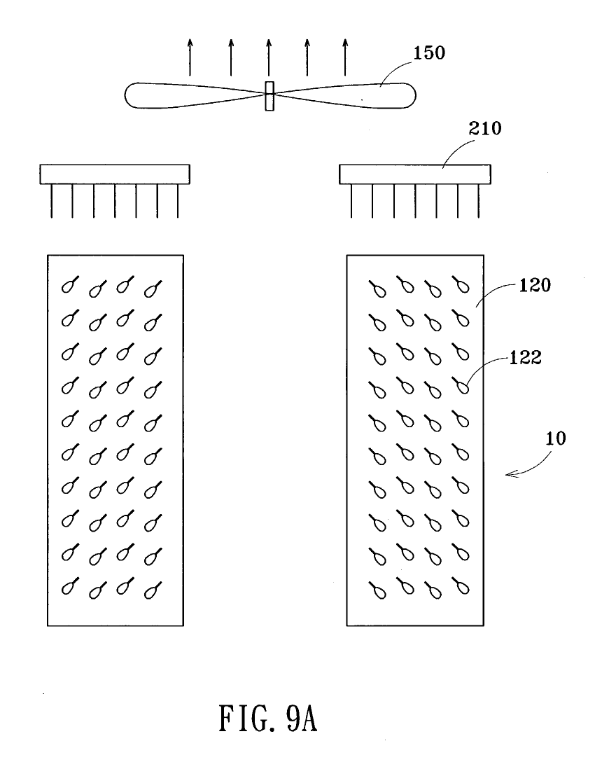

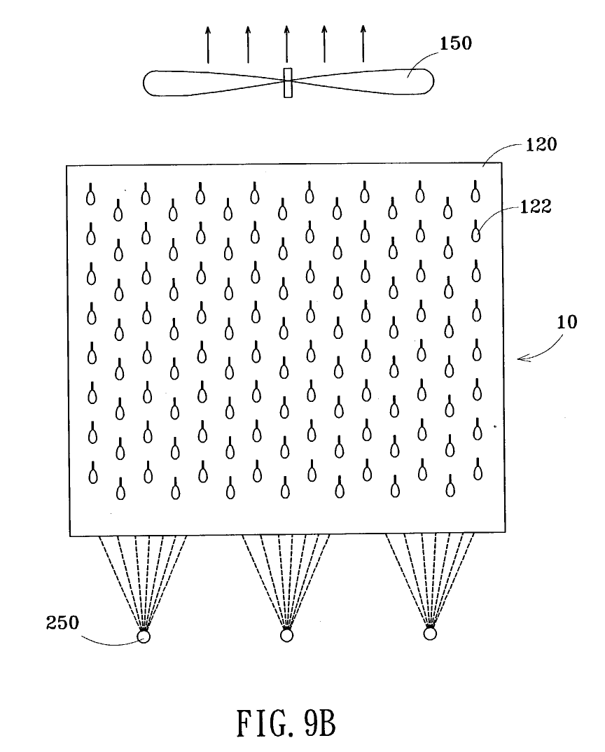

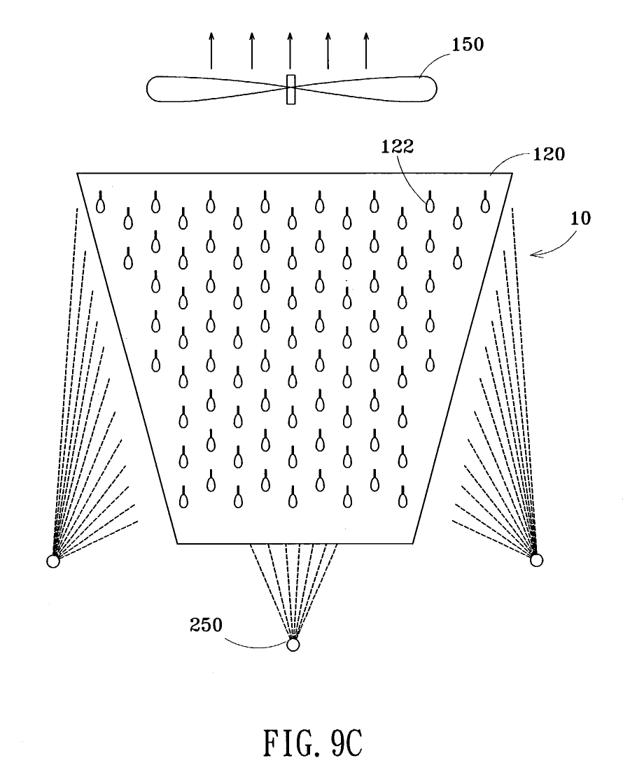

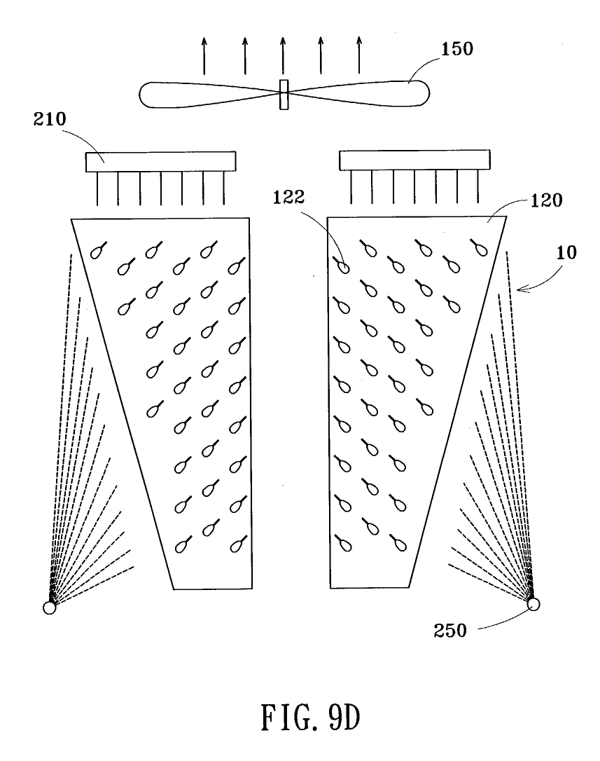

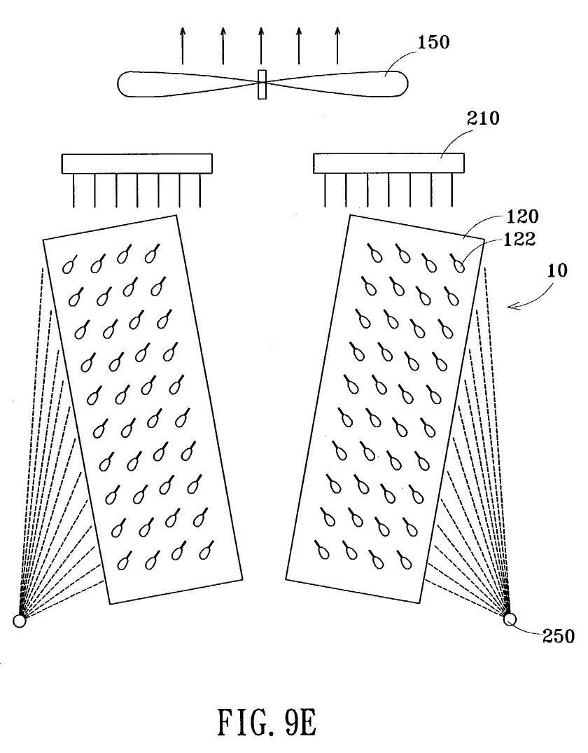

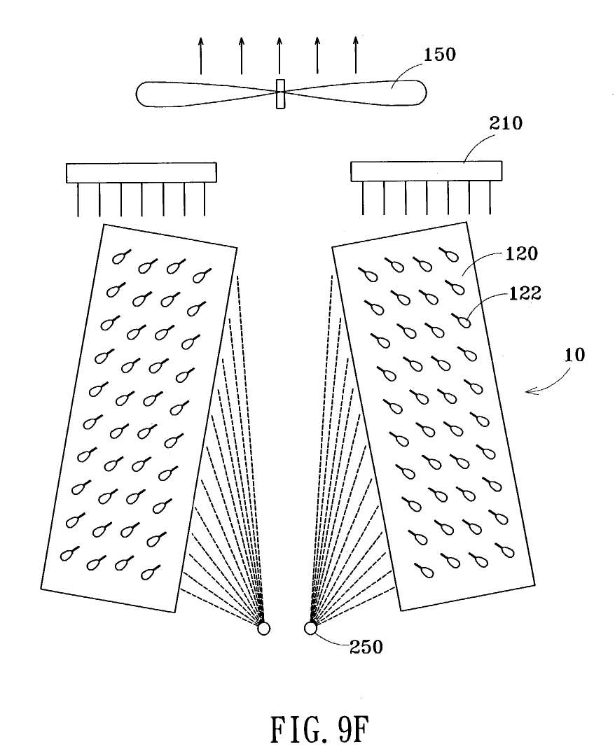

Finally refer to FIGS. 9A to 9F please, there are side views of different embodiment of condensers having the medium coil made of streamlining tubes either with a reduced number cooling fins or even without cooling fins according to the present invention.

Which FIG. 9A shows an embodiment of two heat exchangers 10 disposed in parallel with coils 120 of streamline tubes 122, a fan system 150 disposed at a top center to draw the air flow blows over the streamline tubes 122 and exhausted out upwardly therefrom, a water distributor 210 disposed respectively at a top of each heat exchanger 10 for feeding evaporative water to the coil tubes 122 therefrom.

FIGS. 9B and 9C respectively showing a rectangular and a trapezoid shape heat exchanger 10 having a plurality of vertical streamline tubes 122 of coils 120, a plurality of water spray tubes 250 disposed at a bottom, and a fan system 150 at a top to draw the wind flow upwardly to blow over the streamline tubes 122 therefore.

FIG. 9D is one of the most preferable embodiments according to the present invention, which two trapezoid shaped heat exchangers 10 are disposed in opposite side with coils 120 of streamline tubes 122, respectively having a water distributor 210 at a top thereof and two additional water spray tubes 250 disposed to an opposite outside at a bottom respectively to spray water to an under side surface of the streamline tubes therefore to provide an evaporative water film thereon, a fan system 150 disposed at a top to draw the wind upwardly passing over the surface of streamline tubes 122 therefore.

FIGS. 9E and 9F both consist of two opposite heat exchanger 10 similar to FIG. 9D, which FIG. 9E is composed of a “V” type while FIG. 9F is composed of an “A” type.

It is clear that those figures are just for showing various preferable embodiments according to the present invention only, but not means the limitation of the present invention therefore.

1. An evaporative heat exchanger of a cooling medium condenser with a coil of streamline tubes and a reduced number of cooling fins comprises:
a reduced number of cooling fins disposed vertically in parallel having a wide interval between adjacent fins respectively thereof;
a plurality of streamline cross sectional tube laterally punished through said cooling fins to formed of a cooling medium coil to instead for a conventional round tube coil therefore;
a recycling water feeding system disposed cooperate to feed water onto the surface of said streamline tubes for evaporating thereon;
a wind system disposed for providing an air flow blowing with a direction to all over the surface of said streamline tubes for speeding water evaporation thereon.

2. An evaporative heat exchanger according to claim 1, wherein
said recycling water feeding system comprises:
a water distributor of disposed over a top of said cooling fins for seeping water drops gently and evenly to said streamline tubes thereon;
a water tank disposed at a bottom under said cooling fins to supply evaporated water and to collect residual water dose not evaporated from said streamline tubes;
a water pump disposed to deliver water from said water tank to said water distributor for recycling therefore;
a recycling water pre-cooling heat exchanger disposed at a top of said heat exchanger disposed at a top of said water distributor for cooling recycling water to avoid an over heat due to an accumulating effect of temperature raising of recycling water during a long time running.

3. A recycling water feeding system of an evaporative heat exchanger according to claim 2, wherein said water distributor comprises:
a pad made of water absorptive foaming material to absorb spraying water from said tail tube of said water coil of said recycling water pre-cooling heat exchange and seeping water drops while it is in an over saturated state;
a plurality of water guiding needles downwardly pierced said foaming material pet with the needle tips extruded out of a bottom of said foaming material pad for guiding water seeped out drop by drop therefrom due to a needle tip effect.

4. A recycling water feeding system of an evaporative heat exchanger according to claim 2, wherein said water tank comprises:
a water inlet pipe connected to a water source to refill water for balancing the consumer of evaporated;
a float valve connected to said inlet pipe to control water to a constant level therein;
a timer controlled blow down valve and an outlet tube disposed at a bottom to blow down the recycling water periodically once daily or once by-daily for changing to fresh water automatically therefore;
an over flow exhausting pipe having a horn shaped open end flat to the constant water level and connected to said outlet tube by passed said blow down valve to prevent an over flow from a large amount of residual water falling down to said water tank in the moment of cutting off the apparatus.

5. A recycling water feeding system of an evaporative heat exchanger according to claim 2 wherein said recycling water pre-cooling heat exchanger comprises:
A plurality of vertical cooling fins;
a water coil laterally pierced said cooling fins having an inlet connector connected from said water pump and a tail pipe for spraying water to said foaming material pad of said water distributor thereon.

6. An evaporative heat exchanger of a cooling medium condenser having a coil of streamline tubes avoid to use cooling fins.

7. An evaporative heat exchanger avoiding cooling fins according to claim 6, wherein said coil is composed of a plurality of bare streamline tubes.

8. An evaporative heat exchanger avoiding cooling fins according to claim 6 wherein said coil is composed of a plurality of tadpole cross sectional tubes which a tadpole cross sectional tube is form of streamline cross section having a tail fin extended from a rear edge thereof.
